(19) United States
(12) Patent Application Publication
(10) Pub. No.: US 2011/0208479 A1
(43) Pub. Date: Aug. 25, 2011

(54) ANGLING DATA LOGGING APPARATUS WITH A HORIZONTAL MEASURING WEIGHING PLATFORM

(76) Inventor: Antonio E. Chaves, Olathe, KS (US)

(21) Appl. No.: 12/711,047

(22) Filed: Feb. 23, 2010

(51) Int. Cl. G06F 17/40; A01M 99/00

(52) U.S. Cl. 702/187; 43/1

(57) ABSTRACT

A data receiving and storage device designed to record and display any and all relevant data that might be useful to an angler. A portable platform containing a fish scale, fish measuring apparatus, and a display with a user interface allows an angler to record data on each fish that is caught, including GPS position where the fish was caught and what time of day. The device is capable of storing data for numerous fish and culling fish so that the angler knows to remove smaller fish when the device has determined that the most recently caught fish is larger than one stored in the boat's fish locker.

### BACKGROUND OF THE INVENTION

1. Field of the Invention

The present invention pertains generally to sporting equipment used by anglers and, more specifically, to an apparatus and a method that allows the recording, storage and retrieval of useful information during fishing tournaments or for recreational purposes.

2. Description of the Related Art

A number of patents have been issued for devices and apparatus designed to measure the length and weight of fish. Several patents have been issued on devices and apparatus that incorporate electronic sensors and digital input for recording and displaying fish data. Some of these have emphasized rapidity of measurements, minimum handling of fish, or portability as their main criteria. None of these devices and apparatus incorporates a horizontal rectangular holding platform and a computerized tablet or connection to a GPS/fish finder/chart plotter unit for digital recording, storage and display of information useful to the angler during fishing tournaments or recreational outings. The recorded information includes fish length and weight, water depth and temperature, ambient weather conditions (temperature, precipitation, wind), date and time of catch, lure used, GPS coordinates, location of fish (river, lake, pond), and, if desired, a photograph of the catch. As much or as little of the information may be recorded, transferred or stored in a personal computer for later use. Several of the previous devices rely on vertical suspension of the fish using a hook, net or C-clamps attached to a scale for weighing, while others utilize a trough design to hold the fish for measurement and weighing. None of these devices or apparatus comprises a horizontal holding platform, a computerized tablet and a method of recording detailed information about each fish caught. Measuring a fish in a horizontal method is the standard and lawful way of measuring the length of a fish. Measuring and weighing fish in a horizontal manner offers less handling and reduces stress on the fish as required in most state fishing regulations. This invention is useful to anglers during fishing tournaments or recreational outings as it provides a relatively simple and flexible apparatus and a method for recording, storing and retrieval of as little or as much information as desired by the angler.

U.S. Pat. No. 5,097,617 issued to Craven on Mar. 24, 1992, teaches an apparatus for measuring fish. The invention consists of a trough with indicia at measured intervals from one closed end of the trough to signify the legal limit for various species of fish.

U.S. Pat. No. 5,148,607 issued to Lasiter on Sep. 22, 1992, teaches a fish holding and measuring device and method of use. The invention consists of a rectangular tray open at one end and of a length equal to the minimum legal length established for the type of fish with which the device is to be used. A hinged lid is used to loosely retain the fish to be measured in the device.

U.S. Pat. No. 5,526,575 issued to Hoover et al on Jun. 18, 1996, teaches a fish measuring apparatus. The invention includes an elongated base presenting a fish support base with elongated V-shaped side wall sections in a vertical axis. The length of a fish is measured by comparing to an indicium provided on the support surface at a predetermined distance from the stop.

U.S. Pat. No. 5,637,838 issued to Arey et al on Jun. 10, 1997, teaches an apparatus for measuring, weighing and counting fish. The invention comprises a main body portion having long parallel side edges and short parallel upper and lower edges in a rectangular configuration, a slide member having indicia to measure length of fish, a scale with a coil spring and a hook, a pointer and indicia to weight fish, and a manual counter with a button to count number of fish. This apparatus measures the length of a fish horizontally and records the weight of the fish in a vertical position.

U.S. Pat. No. 5,854,447 issued to Greenwood et al on Dec. 29, 1998, teaches a fish length measuring apparatus and method that measure and display the size of a fish in a digital display. The invention consists of a hand-held net or other support with a built-in digital scale and a method of converting and displaying the weight of the fish into other parameters such as length and/or girth by previously established mathematical principles.

U.S. Pat. No. 6,222,449 issued to Twining on Apr. 24, 2001, teaches a remote fish logging unit for electronically recording relevant information related to fishing conditions, including a touch screen for manually entering information and a display for reviewing information. The device may transfer information to a personal computer or central repository such as a network server which maintains a database of information related to fishing conditions at a number of locations. The portable recording device, however, does not contain a flat, horizontal, rectangular holding frame to facilitate measurement of the fish, and relies on a hook to which may be attached a net or scale holding the fish for weighing. The portable recording device does not contain an integrated measuring device for recording the length of the fish and only mentions adding demarcations to the sensor cable used for probing and measuring water conditions, making it impractical and less accurate than required for fishing tournament conditions.

U.S. Pat. No. 6,594,939 issued to Ondusko on Jul. 22, 2003, teaches a fish measuring device comprised of a fish containment trough and a measuring scale provided within said fish containment trough to measure length of the fish.

U.S. Pat. No. 6,608,261 issued to Thadani on Aug. 19, 2003, teaches a portable fishing scale with retractable handle and built-in mechanical thermometer. The invention comprises a support body having a scale, a suspending member, a display unit that displays the measured weight of the article, a retractable and extendable handle, a tape measure, a temperature probe, and a digital clock. The digital scale consists of a suspending member that suspends an article to be weighed by the scale, a load cell to detect and measure the weight of an article, and a digital display unit. The temperature probe includes a graduated scale with indicia denoting units of temperature measurement.

U.S. Pat. No. 6,696,650 issued to Muller et al on Feb. 24, 2004, teaches a digital fish weighing device. The invention comprises a molded housing having upper and lower portions for supported hand grasping, an electronically controlled weight-sensing member and a viewable digital output screen mounted within the housing. The fish engaging assembly consists of a pair of opposed c-shaped jaws extending downward through an aperture formed in the bottom of the housing. The output screen is electronically connected to the weight-sensing member whereby a weight held by gravity causes a digital numerical display on the output screen equal to the fish weight.

U.S. Pat. No. 6,765,155 issued to Gray on Jul. 20, 2004, teaches a portable measuring device to measure length and weight of fish caught. A stenciled measuring ruler is used to measure the length while a hook chain device is attached to a weight scale for recording fish weight. Two display units attached to the plastic housing show the length and weight of the fish. The invention lacks a method for recording, storage and retrieval of data in an integrated manner with the portable measuring device.

U.S. Pat. No. 6,959,499 issued to Bini on Nov. 1, 2005, teaches a compact and portable measuring device attached to a fish holding device that provides a readable scale to measure the length of the fish. The invention allows for a photograph taken at a distance to record the length of the fish but lacks an apparatus for the electronic recording, storage and retrieval of fishing data.

U.S. Patent Application 2007/0045010 submitted by Kasperek on Mar. 1, 2007, teaches a handheld apparatus for measuring fish. The proposed invention consists of a housing, a scale, a camera, and a length measuring device. The camera is located within the housing and displays an image along with time and date information. A processor within the housing communicates weight information from the scale to the camera for display. The camera displays an image of an object taken by the camera with weight and/or length information for the object.

U.S. Pat. No. 7,408,125 issued to Lentine on Aug. 5, 2008, teaches a fish length measuring apparatus that incorporates a digital scale for both measuring and weighing fish without touching or handling the fish. The apparatus incorporates a housing with a fish-clasping assembly in the form of a lip grip that is used to grasp the mouth of the fish, a weight-sensing scale and an ultrasonic transducer or other distance-measuring device to measure and display length and weight of the fish.

U.S. Pat. No. 7,605,332 issued to Winkler on Oct. 20, 2009, teaches a fish measuring and weighing device integrated into a craft's fishing rod locker compartment, configured to provide a fish holding compartment, a length and weight measurement mechanism, an electronic interface configured to display measurements, and a communication system configured to transmit said measurements to an external device. The electronic interface may be coupled to a depth gauge, a GPS and a temperature gauge. This device is fully integrated into the watercraft and, therefore, lacks convenience and portability. It becomes part of an integral structure in the watercraft.

Heretofore to our knowledge there has not been an apparatus and method capable of recording, storing, and retrieving of useful information such as fish length, weight, ambient conditions, geographical location, and other pertinent data during fishing tournaments or recreational outings, adapted for mobility and accessibility, such as the presently described invention.

### SUMMARY OF THE INVENTION

This device embodies data from elements that quickly and accurately measure, weigh and record data relative to an angler's catch. The unit records and stores all information as desired by the angler, including but not limited to: type of fish caught, time and date caught, angler that caught the fish, weight, length, lure used, color of lure, location (GPS), name of body of water, water temperature, air temperature, weather conditions, water depth, water clarity and a photograph of the catch. As the fish are caught, each fish is placed on the platform of the scale portion and the computerized tablet records the fish in sequential order and data for each fish are recorded. Information about each catch is recorded and saved into the computerized tablet. Some information is input automatically such as weight, length, time when the catch is made, GPS location, etc. Other information is either input manually or pre-programmed into the computerized tablet, such as the name of the lake, river or pond, lure used, angler that caught the fish, photograph and any other information not input automatically from the scale device or other devices connected to the computerized tablet such as a GPS/fish finder/chart plotter unit.

The angler can pre-program the unit to gather as little or as much information as desired. Prior to a fishing trip, the angler can pre-program the device to list the lures typically used by the angler so that when recording information in the unit as the catch is made, the angler has a list of his or her typical baits displayed on the tablet to pick from quickly. The angler may also manually input information quickly and easily by use of the interactive screen on the computerized tablet. Information can be added at a later time as well if desired. As the angler catches and records each fish, a running total of all the fish caught is displayed if so desired. The unit has the capability of recording several anglers' catches; thus, the unit can display a comparison of the anglers' totals. The device can display fish that have been caught and released and fish that are currently in the live well. By recording the start time of a fishing trip, the angler can see when fish were caught relative to the start time.

When the angler catches a fish and wishes to log it in, the angler places the fish on the weighing and measuring platform and at the same time over the built-in measuring tape. When the weight is stable, the angler locks in the weight and the information is transmitted to the computerized tablet in corresponding order of the fish caught. The time is recorded automatically when the weight is locked. Other details of the catch may also be recorded automatically if the unit is connected to an accessory such as an interactive computerized tablet or a GPS/fish finder/chart plotter unit. Additional information, such as length, can be recorded via a laser beam or an electronic strip located on the rail platform by sliding the plastic marker and placing the edge of the marker at the end of the fish's tail, or can be input manually by the angler. All other information is either input manually or automatically as desired by the angler. Items such as lure, color of lure, angler who caught the fish, whether a photo was taken or not, can be input manually or automatically, or copied from the previous catch when the weight is locked in. Using previously entered information by copying details of the previous catch shortens the time required to record data when multiple fish are caught on the same lure under the same ambient conditions and at the same relative location.

The length of the fish can be input manually by placing the fish over the ruler located on the weighing and measuring platform and visually identifying the location of the fish's tail on the ruler. The length can automatically be recorded by sliding the clear plastic marker along the rail to the end of the fish's tail. When the angler is satisfied with the location of the slide, the length is locked and the laser beam or electronic strip measures the length of the fish against a plate located on the slide. This can be tied into the weight scale portion as well. When the angler locks-in the weight of the fish, the laser beam or electronic strip records the length of the fish at the same time. The information is then transmitted to the computerized tablet and tied into the information for the corresponding fish caught. The computerized tablet can be programmed to measure both the length and weight at the same time when the weight is locked in. The length of the fish can also be measured through a series of LED lights connected to light sensors that measure the location of the plastic slide on the weighing and measuring platform when the angler locks in the weight for transmission to the tablet. If a small fish is caught but the weight or length is not desired to be physically recorded, the angler can record a fish without weighing it on the weighing and measuring platform and it will add a fish to the count that is too small to measure (this is usually called a “dink” or “non-keeper” fish). The angler may also add manually the small unmeasured fish to the count when the next fish is caught. The time caught is recorded for the small fish by use of the interactive screen to add the fish to the count without measuring it.

### BRIEF DESCRIPTION OF THE DRAWINGS

FIG. 1 is an isometric drawing showing the weighing/measuring horizontal platform and computer tablet as an integrated unit.

FIG. 2 is a top view of the invention showing the weighing/measuring horizontal platform on one side and the computer tablet on the other. Built into the unit is a ruler with indicia, a laser beam or electronic strip measuring device.

FIG. 3 is a front view of the invention showing location of an on/off switch.

FIG. 4 is a side view of the invention showing the end of the platform and the side rails.

FIG. 5 is a bottom view of the invention showing the location of the weight sensors and battery compartment.

FIG. 6 shows details of the electronic measuring device: a) is an isometric drawing of the laser beam/electronic strip on the horizontal platform; b) is a top view of the laser beam/electronic strip device; c) is a front-end view of the laser beam/electronic strip device; and d) is a detail of the metal marker on the plastic sliding measuring device.

FIG. 7 shows a sample of the display on the computer tablet.

FIG. 8 shows a perspective view and details of the unit incorporated into the lid of a storage compartment or live well of a fishing boat with a) the weighing and measuring platform lid closed and b) the lid open. Additional drawings show side-views of the storage compartment and the weighing and measuring platform with c) both storage compartment lid and platform lid closed; d) weighing and measuring platform lid open and storage compartment lid closed; and e) both lid and weighing/measuring platform open.

FIG. 9 shows a sample of the log that can be created and one of the ways information is compiled as the fish are caught.

FIG. 10 shows an information matrix and the sources of data gathered and recorded on the computer tablet.

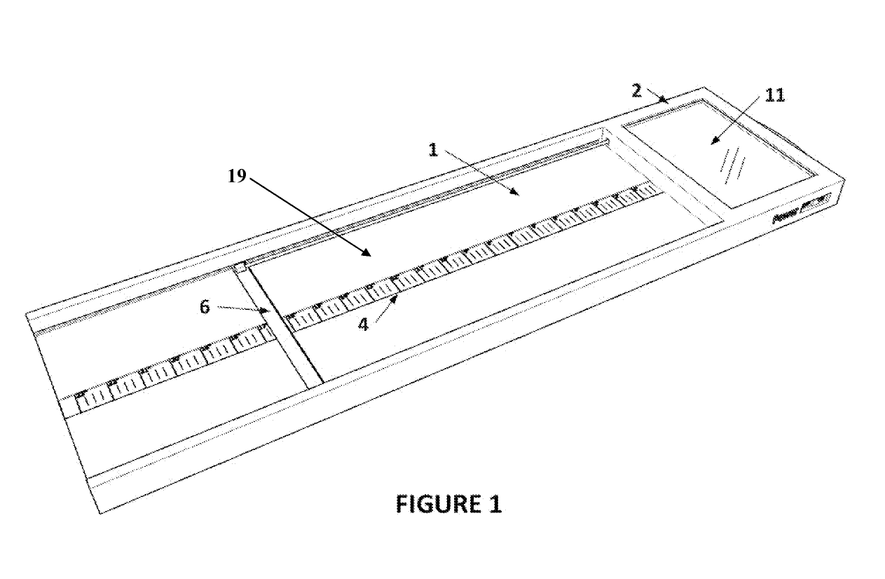

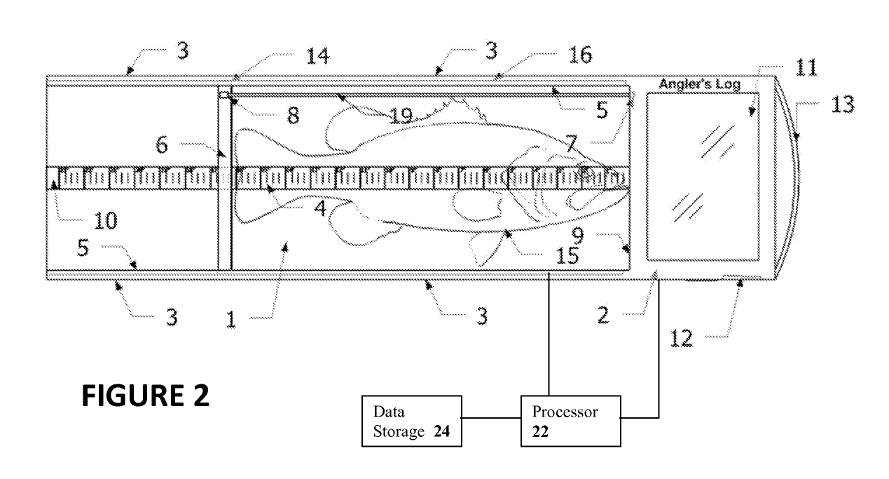

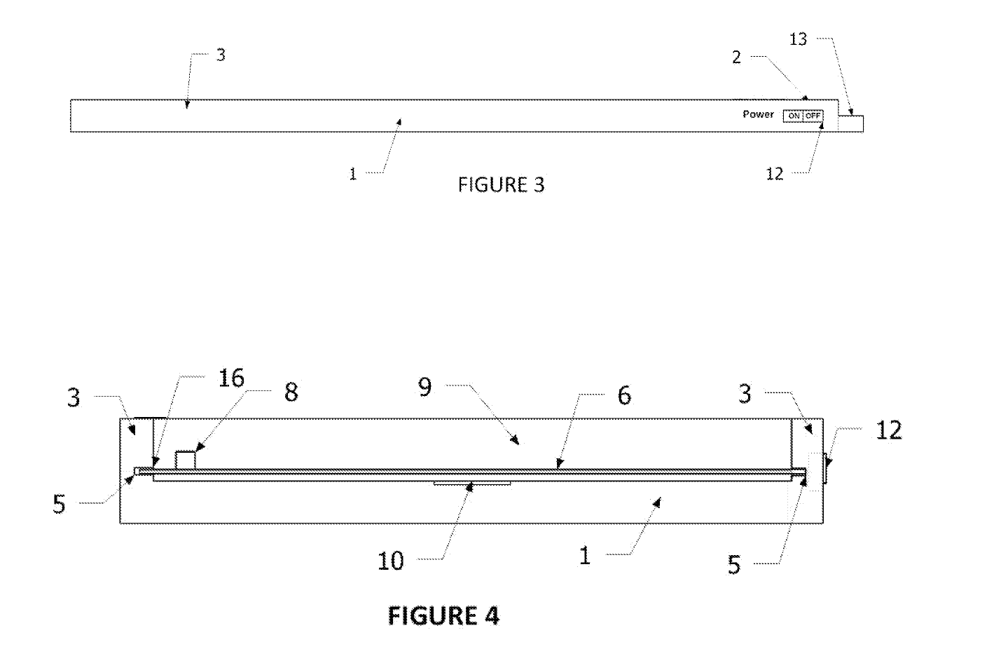

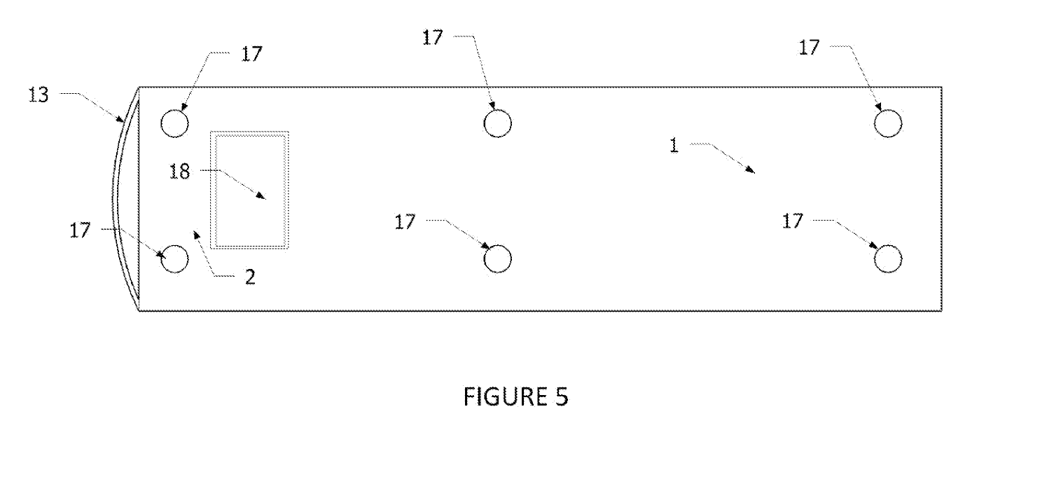

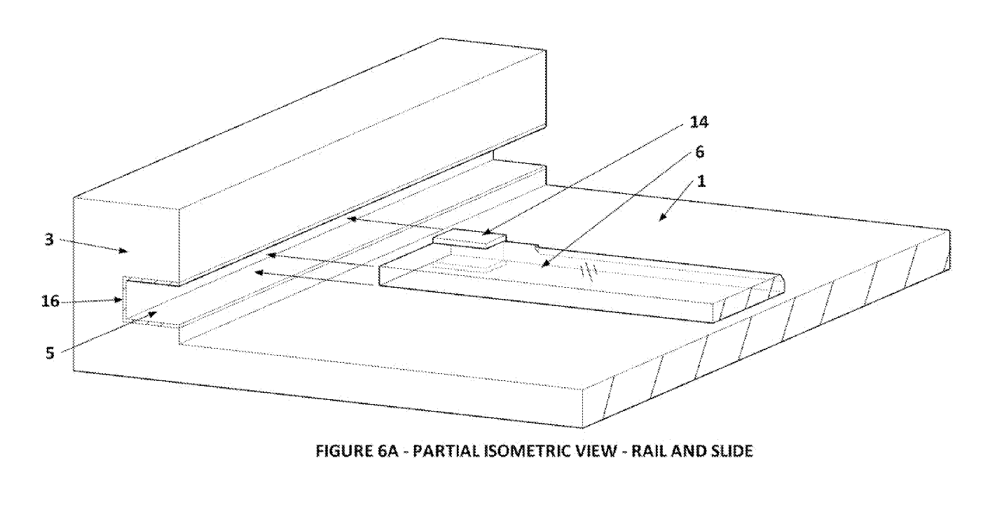

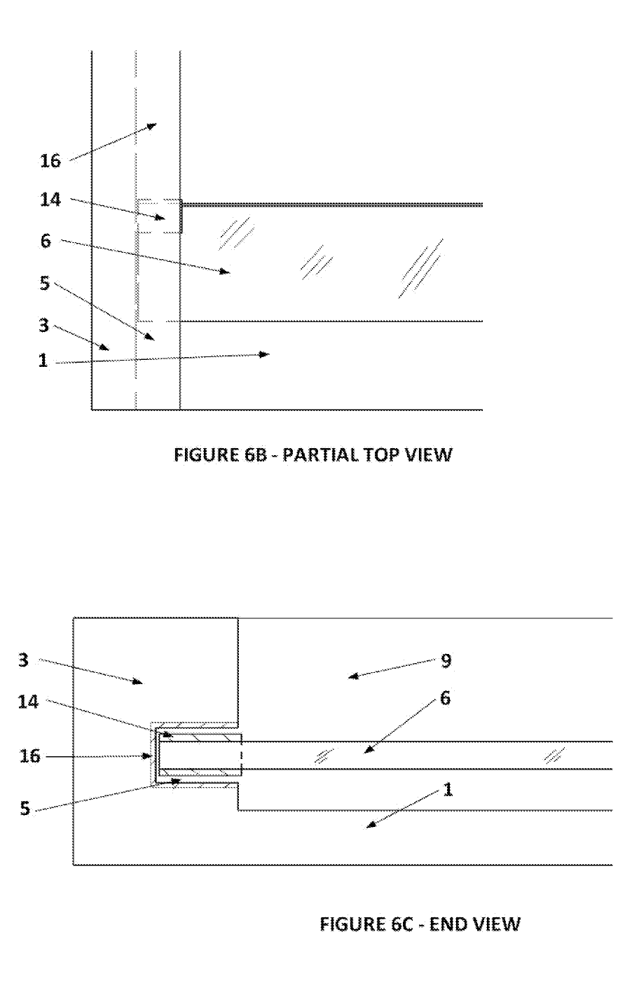

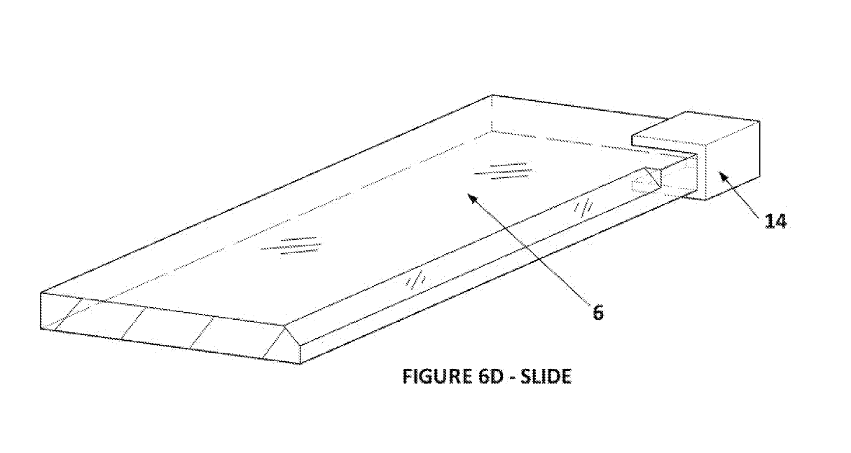

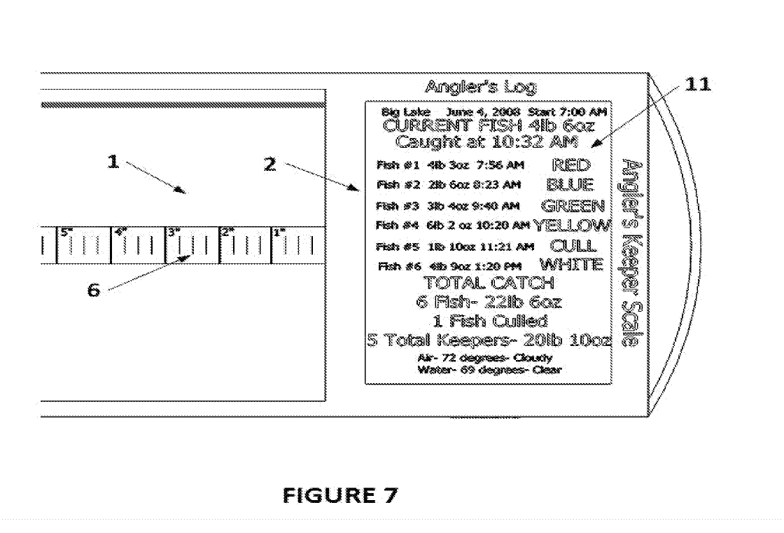

### DESCRIPTION OF THE PREFERRED EMBODIMENT

The device is comprised of a digital scale platform 1 and an interactive computer 2 connected to provide both a measuring tool and a recording device. The computer 2 includes a processor 22 and a data storage device 24, such as a hard disk drive. The digital scale consists of a platform 1 rectangular in shape, made of waterproof material and measuring approximately eight inches wide and 18 to 24 inches long (depending upon the species of fish caught). Several items are incorporated on the platform 1. In the middle of the platform 1 is a ruler 4 with indicia that is inset into the platform 1 parallel to its long axis. Perpendicular to the platform 1 is a clear plastic marker 6 that slides along grooves 5 running parallel to the rails 3 of the platform 1. The angler slides the clear plastic marker 6 to the end of the fish's tail to determine the length of the fish 15. The clear plastic marker 6 has a metal clip 14 on the front corner that rides inside the metal strip 16 in the rail 5 that determines the length of the fish 15 at the same time the fish 15 is weighed. The weight scale portion of the platform 1 of the unit makes up the bulk of this portion of the invention. The scale automatically turns on and tares (zeroes) itself when tapped and automatically turns off after a period of inactivity as determined by the angler. The angler may disable this feature if it is desired for the scale to only turn on when the angler pushes the interactive screen 11 or if the angler prefers the scale to remain on. The weight platform 1 consists of a flat horizontal area where the fish 15 is placed. The fish 15 is placed along the center of the platform 1 laid parallel to the side rails 3 with the tail facing the open end of the weighing platform and the nose held against the head rail 9 for measurement. The apparatus has a master on-off switch 12 to help conserve battery life and a carrying handle 13 to facilitate portability.

Inscribed in the middle of the platform is a ruler 4 so that as the fish 15 is weighed it also can be manually measured for length. Perpendicular to the ruler 4 there is a sliding clear plastic marker 6 that slides over the ruler 4 to aid the angler in remembering the length or in comparing length to a previous catch. The marker 6 can also be moved to mark the legal keeper size of the body of water being fished. If a fish of larger size than the platform 1 is caught, the ruler 4 can be flipped over and extended 10 so that the ruler allows measurement of the full length of the fish by sliding the end of the ruler 4 to the fish's tail and reading the length from the indicia on the ruler 4 at the end of the platform 10.

When the weight of the fish is stable on the scale platform 1, the weight is either locked-in automatically by the scale or the angler can manually lock the weight in by pushing the “enter” or “lock” key on the interactive screen 11. At the bottom of the scale platform 1 a minimum of four weight sensors 17 located at the corners of the scale platform 1 determine the fish's weight and transmit the data to the computer 2. A GPS/fish finder/chart plotter unit 30 can be incorporated in place of the computerized tablet component of the invention. The entire unit can be used as a portable device by use of the battery compartment 18 located at the bottom of the unit.

Metal strip measuring method: When the weight is locked by touching the interactive screen 11, the length is measured at the same time by means of a metal clip 14 attached to the clear plastic slide 6 that slides along a metal electronic strip 16 in the groove 5 along the rail 3. The location of the metal clip 14 relative to the electronic strip 16 in the rail 3 determines the length of the fish 15 relative to the distance to the front rail 9 where the fish's nose is placed against and thus records the length of the fish 15 instantly by sending the signal to the computer 2. The weight, length and time of catch for each fish are input into the corresponding entry in the computer 2 and displayed on the interactive screen 11, say F1 for Fish #1.

Laser or electronic strip measuring method: When the weight is locked by touching the interactive screen 11, the length is measured at the same time with a laser measuring device 7, which includes both a laser source and a laser receiver, located at the front rail 9 of the platform 1. The laser beam 19 reflects off a flat plate 8 located on the slide marker 6 and bounces back to the laser measuring device 7, and thus records the length of the fish instantly and sends the signal to the computer 2. The weight, length and time of catch for each fish are input into the corresponding entry in the computer 2 and displayed on the interactive screen 11, say F1 for fish #1, F2 for fish #2, F3 for fish #3, and so on. Similarly, an electronic strip 16 located on the side rail 3 of the platform 1 may be used to record automatically the length of the fish.

If the computer 2 is connected to a GPS/fish finder/chart plotter unit 30, other information is automatically gathered about the catch such as GPS location, water temperature, air temperature, water depth and any other information recorded by those devices when synchronized with the computer 2. The weight platform 1 can also be directly connected to a GPS/fish finder/chart plotter unit 30.

The display 11 screen of the computer 2 can vary in size and complexity in regards to its capability for gathering as little or as much information and the degree of automation desired by the angler. The more information that is gathered automatically by the unit, the more complex the device becomes. The information is gathered and compiled in order of fish caught. The information is displayed on the interactive screen 11 of the computer 2. The computer 2 consists of several components capable of interacting with the scale platform 1 for weight and the laser measuring device 7 or electronic strip 16 for length. The computer 2 is capable of interacting with other components typically desired by the angler such as a GPS/fish finder/chart plotter unit 30. The computer 2 is capable of automatically receiving and storing angling data such as weight and length of fish caught. The angler can also input information manually by means of an interactive touch screen 11 to record information not automatically recorded by the device such as lure, color of lure, angler that caught the fish, whether a photo was taken or not, and any other data the angler would like to include pertinent to the catch.

Based on the software within the computer 2 portion of the invention, the information logged is displayed for each fish caught. This information is stored into the computer 2 and can be retrieved as desired by the angler at a future date.

For the tournament angler, as in a bass tournament, the computer 2 can assign an identity marker (number, letter, symbol or color) to each fish and can store the information about the fish in the computerized tablet's 2 memory. When a limit is caught, say five fish in the livewell, each with an identity marker assigned and attached to the fish, any subsequent fish caught that is larger than a fish in the live well is indicated by the computer 2 and the identity marker of the smaller fish is then assigned to the larger fish caught. Thus the computer 2 can help the angler identify the smaller fish that needs to be culled. The current method generally used by anglers consists of balancing two fish on a bar scale which is time consuming, less accurate and more stressful to the fish. This invention provides a method that is quicker, more precise and less stressful to the fish. By reducing the amount of time the fish are handled, the better chances are that they will be weighed in alive and subsequently released less stressed and alive back into the water at end of the tournament—an important requirement in fishing tournaments.

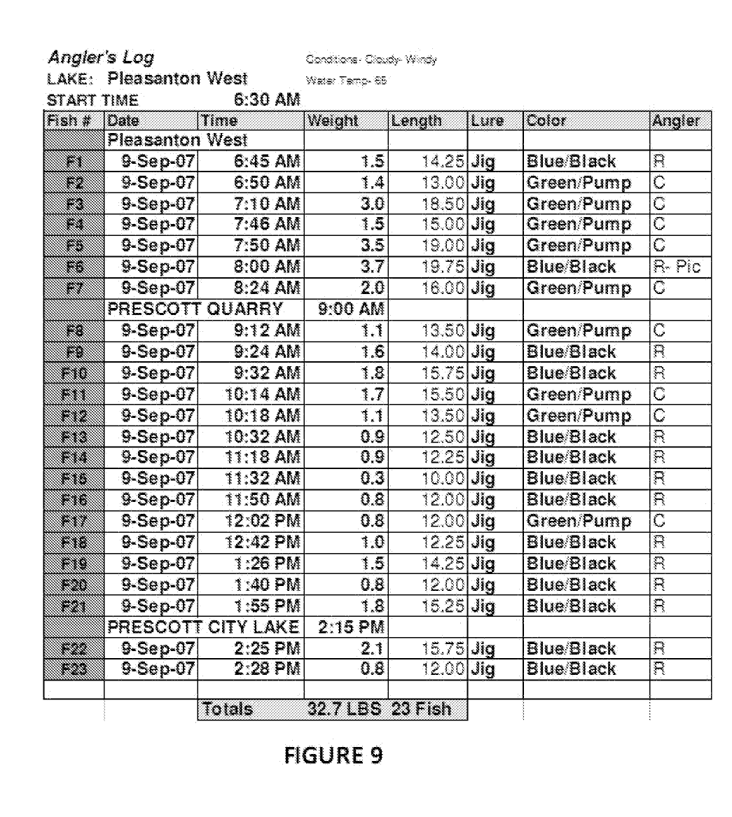

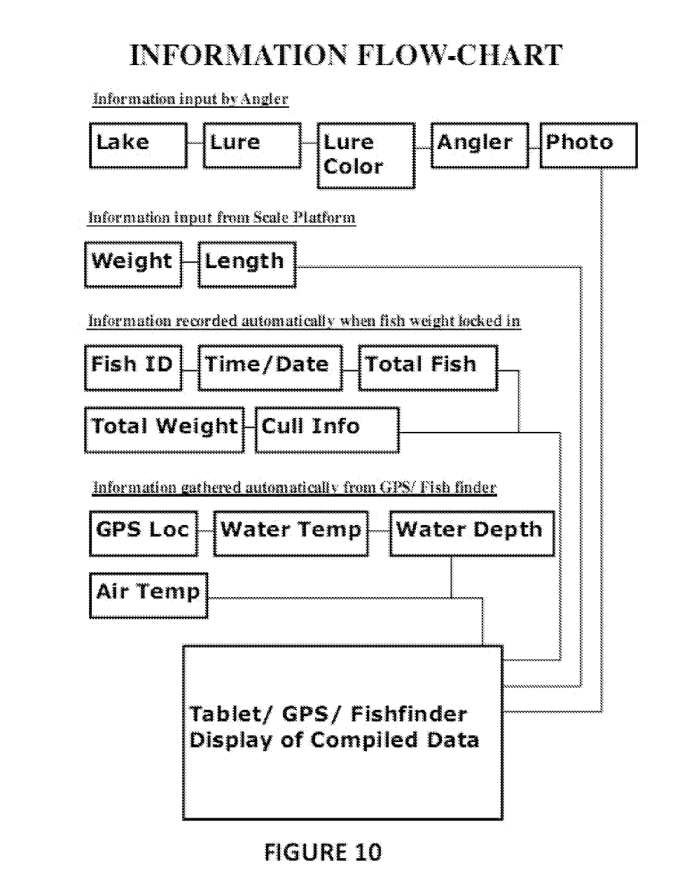

The features that are incorporated into the software of the computer 2 or GPS/fish finder/chart plotter unit 30 are easily manipulated by the angler. The information is input automatically by the weighing/measuring platform 1 and other components connected to the computer 2 or input manually by the angler. The computer 2 is customizable by the angler to display each or all fish caught during a trip or multiple trips. Information stored in the computer 2 may be added to, edited, or reorganized at the discretion of the angler. As photographs are added from a digital camera or a cell phone to the computer 2, each photograph can be tied directly to the fish caught by means of the interactive screen 11 and the photograph can be displayed on the screen. The angler will be able to customize the computer 2 prior to a fishing trip so that when a catch is made, general information is readily and automatically input into the tablet 2. FIG. 9 shows a display of how the log looks on the computerized tablet screen 11. The computer 2 has color capabilities or can be black and white, depending upon the angler's preference. Additional software may be added to a GPS/fish finder/chart plotter unit 30 for measuring and weighing fish, thus allowing full integration of the weighing/measuring platform 1 to currently used electronic apparatus in most fishing boats.

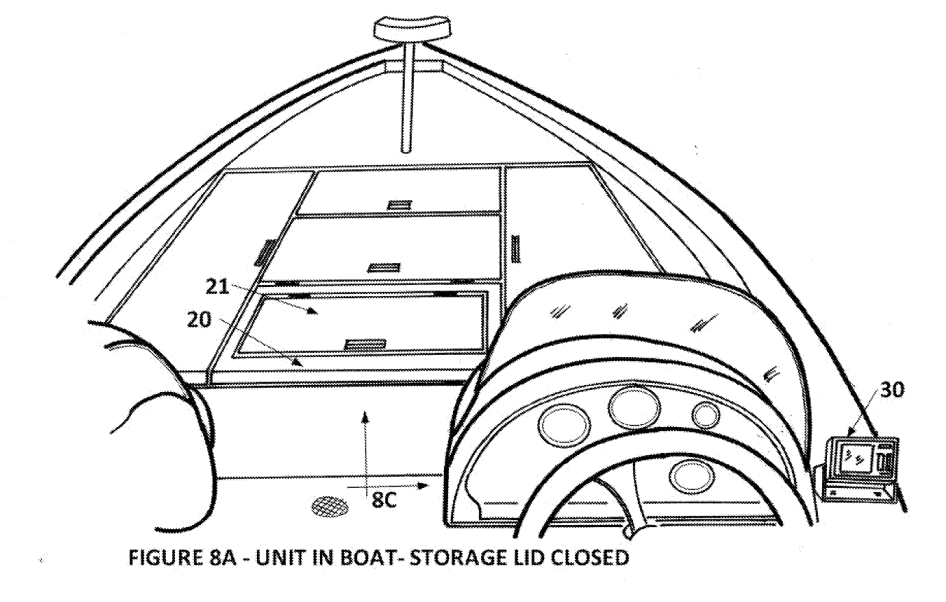

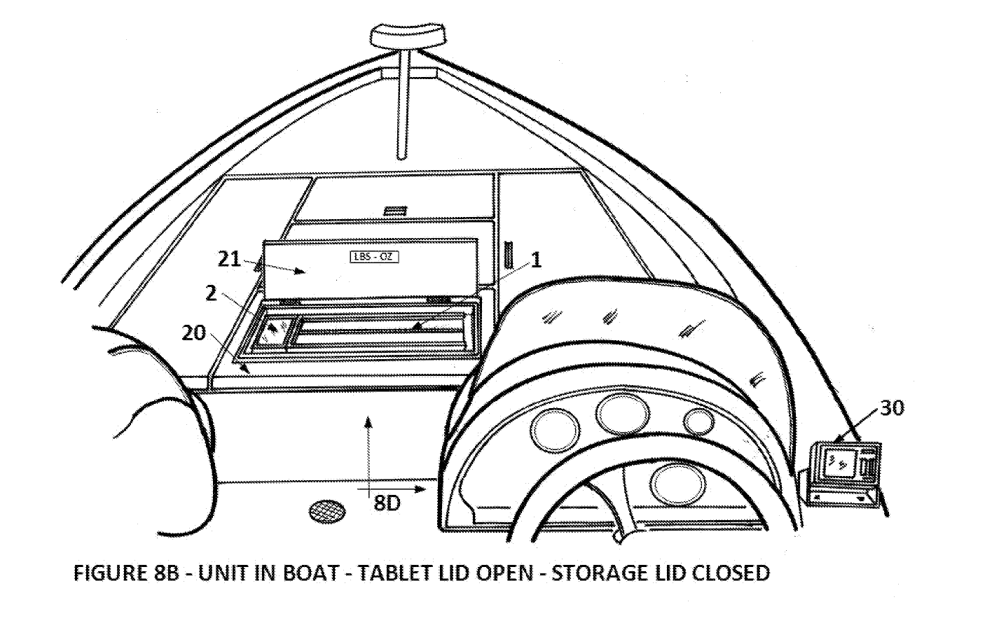

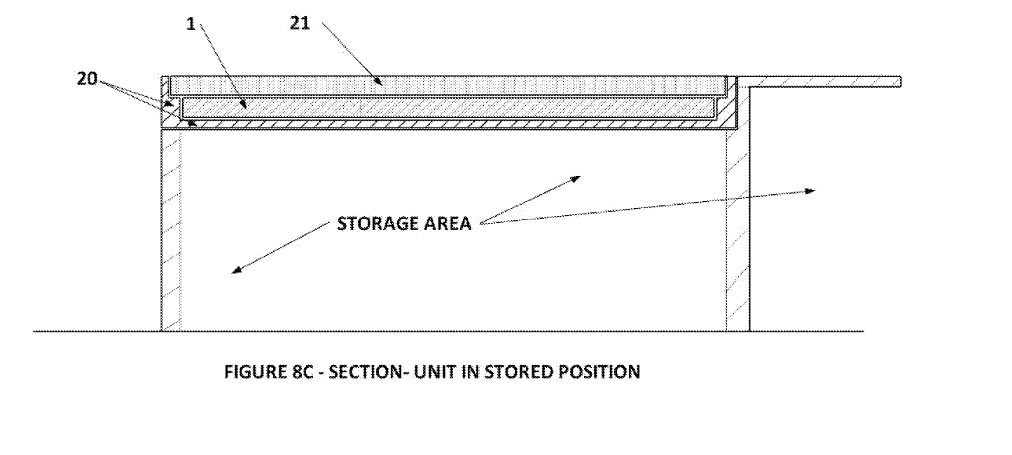

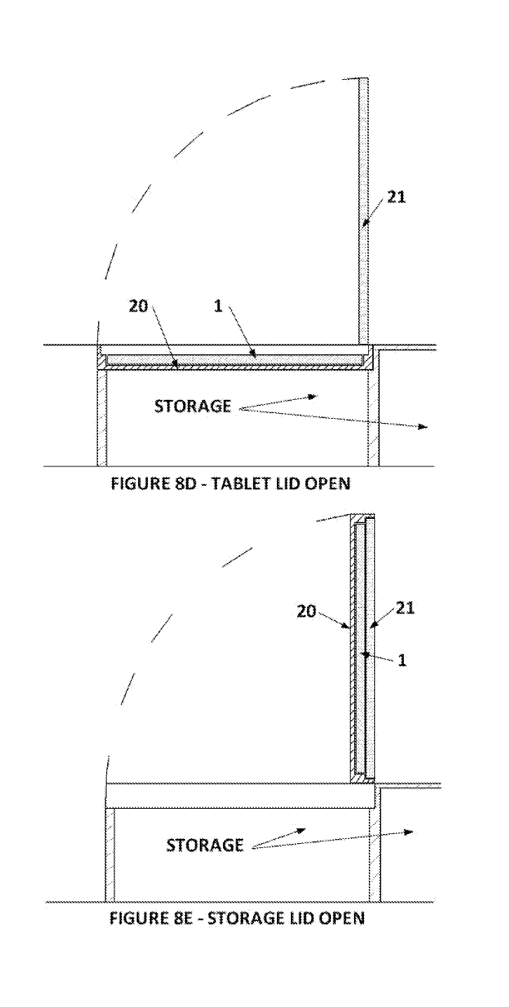

FIG. 8 shows a perspective view and details of the apparatus of this invention incorporated into the lid of a storage compartment or live well of a fishing boat with a) both the storage compartment lid 20 and the weighing/measuring platform lid 21 closed and b) the storage compartment lid 20 and the weighing/measuring platform lid 21 open, exposing both the weighing/measuring platform 1 and computer 2. FIG. 8b shows the spatial relationship between a GPS/chart plotter/fish finder unit 30 and the location of the weighing/measuring platform 1 and computer 2. Additional drawings are side-views of the storage compartment and the weighing/measuring platform 1 showing c) both the storage compartment lid 20 and the weighing/measuring platform lid 21 closed; d) the weighing/measuring platform lid 21 open and the storage compartment lid closed 20; and e) both the storage compartment lid 20 and weighing/measuring platform lid 21 open. The weighing/measuring platform 1 uses very little space when stored in this manner and is accessible at the level of the boat deck where the fish can be measured comfortably and the compartment can be used as a wall or barrier to keep the fish from flopping on the deck.

A restraining device to prevent fish from moving or flopping unnecessarily while placed on the weighing platform for weighing and measuring can be attached to the apparatus of this invention. The restraining device comprises a net or cover made of light and flexible material designed to cause the least possible harm to the fish. The restraining device can be attached to the lid of the boat storage compartment and can readily be placed over the fish while it is weighed and measured to restrain its movement and give more accurate results.

The above description and illustrations of the preferred embodiment of the present invention represents only one example of the apparatus and method used to obtain, record, store and retrieve data by anglers during fishing tournaments or recreational outings, as presently contemplated by the inventor. Sufficient detail has been disclosed to enable anyone skillful in the art to practice the invention as described in its preferred embodiment. This is not intended to limit the invention to the exact design, materials, dimensions, method and operation shown and described. Other modifications, alternative constructions, changes and equivalents may be made by those skillful in the art without departing from the true spirit and scope of the invention. Such modifications might involve different materials, components, structural arrangements, sizes, shapes, forms, functions, operational features or the like.

Having thus described the invention, what is claimed as new and desired to be secured by Letters Patent is:

1. A data logging apparatus for keeping a log of items, which apparatus comprises:
an electronic scale including a platform and providing an electronic signal output corresponding to an item's weight;
a computer connected to the scale and including a processor and a display device adapted for visually displaying the weight; and
said computer including a data storage device connected to the processor and adapted for storing and retrieving the item weight.

2. The data logging apparatus of claim 1 adapted for incorporation into the lid of a storage compartment.

3. The data logging apparatus of claim 1, wherein said computer is a personal computer including a touch-screen user interface.

4. The data logging apparatus of claim 1, further comprising:
a length measuring device for measuring the length of the logged item; and
said computer data storage device adapted for storing and retrieving the item length.

5. The data logging apparatus of claim 4, wherein the device for measuring and recording the length of a fish comprises a laser measuring a device.

6. The data logging apparatus of claim 4, wherein the device for measuring and recording the length of a fish comprises an electronic strip.

7. The data logging apparatus of claim 2, wherein said computer is programmed for receiving and storing additional data comprising one or more of:
date and time of a fish catch;
name of angler;
description of fishing location body of water;
GPS coordinates;
weather conditions including air temperature, water temperature, wind, and precipitation;
water depth and clarity;
type of lure; and
description of lure; wherein
said computer data storage device adapted for storing and retrieving data logged using said user interface.

8. The data logging apparatus of claim 1, wherein:
said computer being programmed to identify the smallest item recorded item;
said computer adapted for alerting the operator to replace the smallest item with larger item; and
said computer being programmed to tracking date and time when such items are culled.

9. The data logging apparatus of claim 1, further comprising:
an identification marking tool adapted for marking weighed items individually corresponding to collected item information; and
said computer data storage device adapted for storing and retrieving data related to item identification markings.

10. The data logging apparatus of claim 1, including:
a camera adapted for taking a photograph of the item at the time the item is weighed by said electronic scale; and
said computer data storage device adapted for storage of said electronic signal for display and retrieval of item photographs.

11. The data logging apparatus of claim 1, further comprising:
a portable additional data storage device adapted for facilitating the storage and transmission of item data recorded by the computer; and
an interface adapted for transmitting the item data from the computer to said portable storage device.

12. The data logging apparatus of claim 2, further comprising one or more of:
a GPS device including a display;
an electronic fish finder device including a display; or
a chart plotter device including a display; wherein
said external device being electronically connected to said computer; and
said external device display adapted to display item information stored on said computer.

13. The data logging apparatus of claim 1, further comprising:
an item restraining device connected to said electronic scale platform; and
said item restraining device being of a light, durable, and flexible material.

14. A data logging apparatus for keeping a log of caught fish and adapted for temporary placement into the lid of a storage compartment located on a fishing vessel, which apparatus comprises:
a computer connected to the scale and including a processor and a display device adapted for visually displaying fish data;
said computer including a data storage device connected to the processor and adapted for storing and retrieving fish data;
an electronic scale including a platform and providing an electronic signal output corresponding to an fish's weight;
a length measuring device for measuring the length of the logged fish;
a fish restraining device comprised of a light, flexible, and durable material connected to said electronic scale platform;
a user interface device connected to said computer adapted for providing additional data input to said computer;
said computer is programmed for receiving and storing additional data comprising one or more of: date and time of catch; name of angler; description of fishing location body of water; GPS coordinates; weather conditions including air temperature, water temperature, wind, and precipitation; water depth and clarity; type of lure; and description of lure;
a camera adapted for taking a photograph at the time a fish is weighed by said electronic scale;
a portable additional data storage device adapted for facilitating the storage and transmission of fish data recorded by the computer; and
an interface adapted for transmitting the fish data from said computer to said portable storage device.
said computer being programmed to identify the smallest fish in a vessel's fish storage compartment;
said computer adapted for alerting the operator to replace the smallest item with larger item; and
said computer being programmed to tracking date and time when such items are culled.

15. The data logging apparatus of claim 14, further comprising one or more of:
a GPS device including a display;
an electronic fish finder device including a display; or
a chart plotter device including a display; wherein
said external device being electronically connected to said computer; and
said external device display adapted to display item information stored on said computer.

16. A method of logging the characteristics of caught fish comprising the steps of:
providing an electronic scale including a platform;
providing a computer including a processor, a data storage device, and a display device;
connecting said electronic scale to said computer processor;
placing an item onto said electronic scale;
generating an electronic output signal corresponding to the placed item's weight;
inputting said electronic output signal to said computer as an item weight value;
storing the item weight value in said data storage device; and
outputting said item weight value to said display device.

17. The method of claim 16, further comprising the steps of:
providing a user interface device;
electronically connecting said user interface device to said computer; and
programming the computer for receiving and storing additional data comprising one or more of:
date and time of a fish catch; name of angler; description of the fishing location; GPS coordinates of the fishing location; weather conditions; water depth and clarity; type of lure used; and description of lure used.

18. The method of claim 16, wherein the computer is a personal computer including a touch-screen user interface

19. The method of claim 16, including the steps of:
providing a device for measuring and recording the length of the item; and
storing recorded item length data into said computer data storage device.

20. The method of claim 16, including the steps of:
identifying each item with an identifier code;
storing said identifier code in said data storage device; and
storing all additional data pertaining to each specific item based on said item identifier code.

21. The method of claim 16, including the steps of:
identifying smallest item stored in the storage compartment;
alerting the operator to replace the smallest item with the present, larger item;
replacing smallest item with next largest; and
recording the date, time, characteristics, and location where such item culling occurs with said computer data storage device.

22. The method of claim 16, including the steps of:
providing a camera;
recording a photographic image of each item as it is measured; and
storing the photographic image of the item with said computer data storage device along with the recorded measurements of the item.

23. The method of claim 16, including the steps of:
providing a portable additional data storage device;
connecting said portable data storage device to said computer; and
transferring stored item data from the computer data storage device to said portable data storage device.

24. The method of claim 16, including the steps of:
providing an electronic fish finding device;
providing an electronic GPS device;
selectively displaying information produced by the fish finding device and GPS device on the display; and
selectively storing data provided by said fish finding device and GPS device into the computer data storage device.

25. The method of claim 16, including the steps of:
providing an item restraining device comprised of a light, flexible, durable material;
physically attaching said restraining device to said electronic scale platform; and
restraining item said platform prior to collecting item data.
